(19) United States
(12) Patent Application Publication
(10) Pub. No.: US 2021/0326942 A1
(43) Pub. Date: Oct. 21, 2021

(54) Method of Securing Online Merchant Reviews Using Block Chains

(71) Applicants: Zachariah Marcus Peterson, (US); Michael Allen, (US); Tom Boyle, (US)

(72) Inventors: Zachariah Marcus Peterson, Portland, OR (US); Michael Allen, West Linn, OR (US); Tom Boyle, West Linn, OR (US)

(73) Assignees: Zachariah Marcus Peterson, Portland, OR (US); Michael Marcus Allen, West Linn, OR (US); Tom Marcus Boyle, West Linn, OR (US)

(21) Appl. No.: 16/849,996

(22) Filed: Apr. 16, 2020

(51) Int. Cl. G06Q 30/02; G06Q 30/06; H04L 9/06

(52) U.S. Cl. CPC G06Q 30/0282; G06Q 30/0248; H04L 2209/38; G06Q 30/0609; H04L 9/0643; G06Q 30/0217

(57) ABSTRACT

The invention provides a method for gathering and showcasing validated customer reviews of online merchants. The invention is comprised of three parts: a first part being a web page plugin application; a second part being a cloud software platform; and a third part being a block chain network. When a customer makes a purchase, the plugin (embedded on merchant's website) asks them if they would like to leave a review. Once accepted, the software links the customer with the merchant's identification and they are redirected to the invention's webpage. After a review is posted it is then validated and stored on a secure ledger that is part of a block chain. Merchants are allowed to post replies that are stored on the block chain. Reviews and replies are displayed publically on the invention's website. An object of the invention is to minimize false reviews of online merchants.

### CROSS-REFERENCE TO RELATED APPLICATIONS

This application claims the benefit of U.S. Provisional Patent Application Titled ‘Method of Securing Online Merchant Reviews Using Block Chains.’

### FIELD OF THE INVENTION

The present invention generally relates to online reviews. More specifically, it relates to a method for validating and securing online feedback using block chains.

### BACKGROUND

Block chain was first invented by Satoshi Nakamoto in 2008. Nakamoto developed the software to serve as a public, transaction ledger for the crypto currency known as ‘bitcoin.’ The invention of the block chain software for bitcoin made it the first digital currency without the need of a trusted authority or central server such as a bank. Bitcoin relies on the block chain for its secure ledger capabilities. Since this time, block chain has been used in other settings besides financial security. Each block in the software contains a cryptographic hash of the previous block, a timestamp, and transaction data. By design, a block chain is resistant to modification of the data. For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. Combined with smart contracts, such blockchains can be considered a decentralized notary service that allows for transparency so that anyone with preset privileges can see what is inside a data element record constructed using cryptographic hash and time stamped. Smart contracts are dynamic, live contracts that once created cannot be changed but can perform certain actions when certain conditions are met—such as sharing records automatically with pre-approved parties using digital signatures.

While the financial industries have been slow to adopt decentralized online purchasing models and transactions, only a few have been developing methods of enhancing online reviews using block chain technology. Chinese Patent No. CN107358500 teaches of a means to secure customer feedback and purchase ratings; however, ledgers appear to be linked to users who register accounts rather than linking to individual, online transactions. Existing online feedback systems (such as those on large commercial purchasing sites like Amazon and Alibaba etc.) can suffer from credibility and trust issues when vendors and sellers generate false feedback to boost sales. More recently, separate review websites have become available to combat fake reviews such as trust pilot, site jabber, rip off report etc., however these sites allow any individuals who may have never made a purchase to write fake negative reviews without verification. An object of the invention in this disclosure is to minimize feedback abuse. The system of this invention is deployed on the block chain, using a block chain as a distributed ledger, on which the operations cannot be changed or revoked. This ensures that feedback is secure and transparent. Furthermore, since the anonymity of the block chain protects the consumer providing feedback, their identifying information is not leaked.

### SUMMARY OF THE INVENTION

The invention provides a method for gathering and showcasing validated customer reviews of online merchants. An object of the invention is to minimize false, online reviews from bad actors. Using the invention, reviewers are required to make a purchase on a participating website. A customer's identity is validated when they make the online purchase via existing, proven transaction methods when a credit card is used. Once a transaction is completed the customer has the option of commencing the review process. The option only becomes available after a validated transaction where the customer's identity is validated—only those individuals who have been properly identified and have had a formal interaction with a merchant and their products and services is allowed to generate a review. Leveraging existing, online validation systems prevents those who have not made a purchase to generate false and sometimes damaging reviews.

Another object of the invention is to enhance reviewer validation by linking transaction information with a reviewer. When a customer opts to write a review, they are redirected to the invention's website and the identity of the merchant or vendor along with the product number is carried over with them.

Another object of the invention is to facilitate the review process. Once at the site, validated customers are presented with review options—such as selecting a type of star rating and recording their direct thoughts in text fields.

Another object of the invention is to securely archive reviews. After a review is completed, it is recorded using encryption software on a distributed ledger as part of the block chain and stored on a secured cloud network. Access to the block chain is controlled by a single, centralized-party using ‘public-private key’ encryption methods.

Another object of the invention is to allow merchants the opportunity to reply to a customer review. When a merchant subscribes to the service they are linked to a customer's review node on the block chain and are notified when a review is recorded immediately. They then have the option to log into the website and leave a reply. These features helps a merchant identify any problems and allows them to work quickly to resolve any customer disputes in order to maintain a positive reputation.

Another object of the invention is to allow the public and potential customers to peruse and examine the aforementioned, validated reviews and replies. The public is encouraged to visit the invention's website. They can view reviews by online merchant name or by product name.

Another object of the invention is to make the review process convenient for online merchants. The user can easily incorporate the feature into their website without generating any new, costly HTML code. Once a user subscribes to a service, they receive a ‘plugin’ software application that is easily inserted into their website backend using popular website editing programs.

Another object of the invention is to incentivize customers to take the time to write a review. In some embodiments of the invention, a merchant may opt to provide a discount on future purchases to those who write a review.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should nor be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 showing customers and merchants posting reviews and replies using the invention.

FIG. 2 showing the overall method process of the invention.

FIG. 3 showing a representative view of the functions of the invention.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

FIG. 1 showing customer 2 and merchant 6 posting reviews and replies using the invention on a mobile device 3 and a desktop computer 5 respectively and interacting with server hosting invention software 4. The aforementioned invention software 4 being written from code that may include, but not be limited to: Java, C++, Visual Basic, Fortran, Basic and the like. The software also compatible with a plurality of operating systems such as, but not limited to: Windows Apple and Android and compatible with a multitude of hardware platforms such as, but not limited to: personal desktops 5, laptops, tablets 28, smartphones 3 and the like.

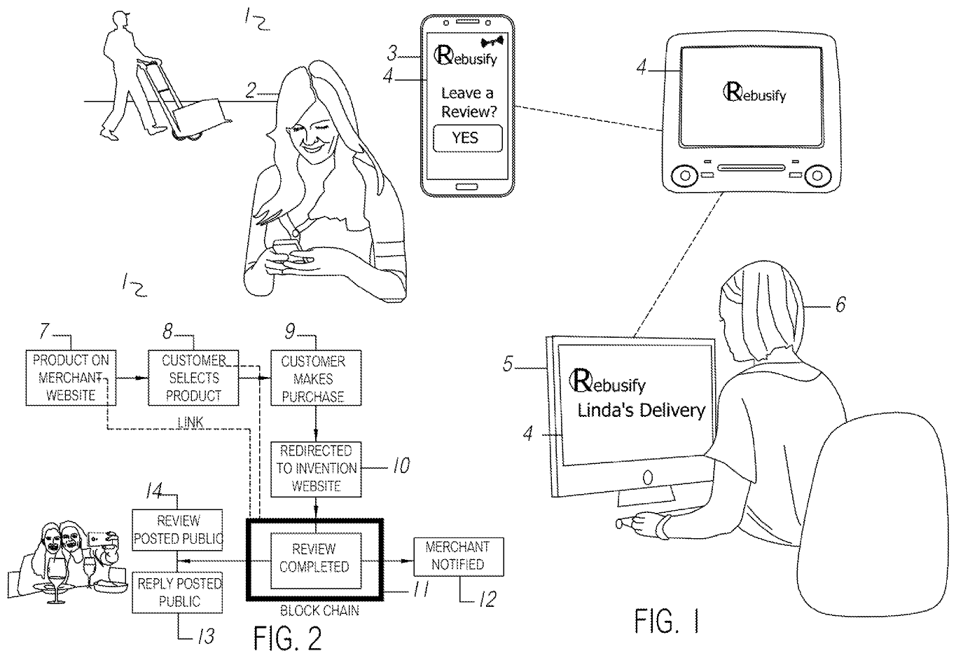

FIG. 2 showing the overall method process of the invention. In a first step 7 an online merchant's product being available on their website and is selected by a customer in second step 8. In step 9 the customer purchasing item with a credit card and information regarding said customer is validated by conventional online financial transaction methods. In step 10 a user is asked to write a review within at least but not limited to 30 days and is redirected to the invention website. In step 11 the customer inputting a review comprised of, but not limited to text strings and selecting stars representing positive and negative values. Once completed, said reviews being saved as a file, becoming a ‘transaction’ and assigned meta data including but not limited to a time and date stamp, an identifier and the like and being assigned a hash on a block chain. Said block chain also linking to the merchant's identification number and creating an identification for the customer as part of said hash on the blockchain. Said identifiers being generated cryptographically and is part of the block chain's public/private key pair governed only by the invention administrators. This creative use of public/private keys prevents anyone except those who have made a purchase from creating valid reviews. After reviews have been established on the block chain, they are made available on the invention's website for public viewing in step 14 and the merchant is automatically notified of said posting in step 12. The merchant having the option to post replies to the block chain that also appear on the website for public viewing. If multiple replies are generated, the invention constructing a chain of messages in chronological order according to time stamps on said block chain therein.

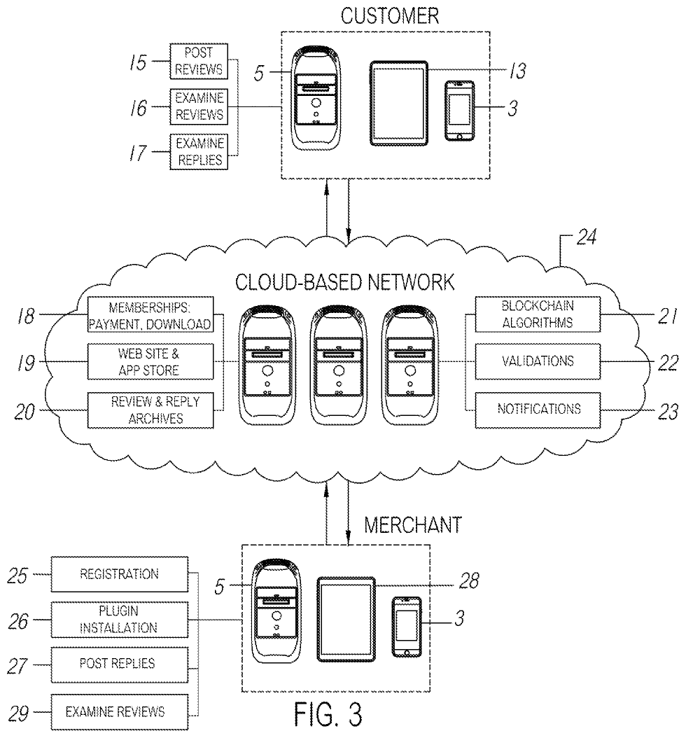

FIG. 3 showing a representative view of the functions of the invention. The figure showing merchants registering for a service plan on the invention 25—such as but not limited to: free, lite and professional etc. offering various numbers of ‘transactions’ (customer review opportunities). Merchants installing the invention's software plugin within their own website HTML code 26, posting replies 27 to customer reviews, as well as examining customer reviews 29 on computing devices such as, but not limited to desktop computers 5, tablets 28 and mobile smart phones 3. The figure showing customers functionality with the invention including but not limited to posting reviews 15, examining others reviews 16 and examining merchant replies 17 on computing devices such as, but not limited to desktop computers 5, tablets 28 and mobile smart phones 3. FIG. 3 also showing the invention's cloud-based network 24 having software performing routines including but not limited to: membership registrations, payments and plugin downloads 18, website and mobile application features 19, reviews and replies archives 20, block chain algorithms 21, merchant and customer validations 22 and block chain and account notifications 23.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1.) A system for minimizing false, online reviews comprised of the following parts:
a) a software program;
b) a website;
c) a cloud network; and
d) a website plugin.

2.) The system for minimizing false, online reviews of claim 1 wherein the software program having block chain operations.

3.) The system for minimizing false, online reviews of claim 1 wherein the software program, website and block chain operations residing on the cloud network.

4.) A method for minimizing false, online reviews comprised of the following steps:
a) Registering for a merchant service plan;
b) Purchasing on a participating website;
c) Validating customer identity;
d) Incentivizing customer review;
e) Writing a customer a review;
f) Linking transaction information to a reviewer;
g) Facilitating customer reviews;
h) Archiving customer reviews;
i) Replying to a customer review by merchant;
j) Examining reviews by public and potential customers and replies;
k) Transferring customer reviews to a merchant's website.

5.) A method for minimizing false, online reviews of claim 4 wherein the validating customer identity including the step of matching a user to their credit card.

6.) A method for minimizing false, online reviews of claim 4 wherein the incentivizing customer review including the step of providing discounts on future purchases.

7.) A method for minimizing false, online reviews of claim 4 wherein the linking transaction information to a reviewer including the step of performing the link with block chain operations.

8.) A method for minimizing false, online reviews of claim 4 wherein the performing the link with block chain operations of claim 5 including the steps of linking product number, the transaction becoming a file and assigning meta data to the file and including a time and date stamp, an identifier and being assigned a hash on the block chain of claim 1.

9.) A method for minimizing false, online reviews of claim 4 wherein the facilitating customer reviews includes the step of selecting star ratings and recording thoughts in text fields.

10.) A method for minimizing false, online reviews of claim 4 wherein the archiving customer reviews includes the step of encrypting on a distributed ledger as part of the block chain and storing the block chain on the secured cloud network of claim 1.

11.) A method for minimizing false, online reviews of claim 4 wherein the replying to a customer review by merchant including the steps of linking merchant replies to customer reviews on the block chain distributed ledger of claim 1.

12.) A method for minimizing false, online reviews of claim 4 wherein the examining customer reviews and merchant replies by public and potential customers including the steps of examining the website of claim 1.

13.) A method for minimizing false, online reviews of claim 4 wherein the transferring customer reviews to a merchant's website including the steps of using the website plugin of claim 1.
